(19) United States
(12) Patent Application Publication
(10) Pub. No.: US 2026/0111909 A1
(43) Pub. Date: Apr. 23, 2026

(54) GREENHOUSE GAS EMISSION REMEDIATION

(71) Applicant: International Business Machines Corporation, Armonk, NY (US)

(72) Inventors: Kamal Chandra DAS, New Delhi (IN); Ranjini Bangalore GURUPRASAD, Bangalore (IN); Jagabondhu HAZRA, Bangalore (IN); Hendrik F. HAMANN, Bedford, NY (US)

(21) Appl. No.: 18/920,148

(22) Filed: Oct. 18, 2024

(51) Int. Cl. G06Q 30/018; G06F 9/451; G06N 5/04

(52) U.S. Cl. CPC G06Q 30/018; G06F 9/451; G06N 5/04

(57) ABSTRACT

Methods, computer program products, and systems are presented. The method computer program products, and systems can include, for instance: identifying emission pixels of a geospatial image map in dependence on periodically collected nitrogen dioxide concentration data and on periodically collected column averaged carbon dioxide concentration data; determining foreground column averaged carbon dioxide concentration data within the emission pixels in dependence on a relationship between nitrogen dioxide concentration data of the periodically collected nitrogen dioxide concentration data and column averaged carbon dioxide concentration data periodically collected column averaged carbon dioxide concentration data; and training a machine learning model using column averaged carbon dioxide data of the foreground column averaged carbon dioxide concentration data.

### BACKGROUND

Greenhouse gas (GHG) emissions, which contribute to global warming, include carbon dioxide (CO₂) from fossil fuels, deforestation, and industry; methane (CH₄) from energy production, agriculture, and waste decay; and nitrous oxide (N₂O) from agriculture and industrial activities. Synthetic fluorinated gases, such as HFCs, PFCs, SF₆, and NF₃, are also significant contributors, often used in refrigeration and industrial processes. While CO₂ is the most common, methane and nitrous oxide are more potent in trapping heat, though present in smaller amounts.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: identifying emission pixels of a geospatial image map in dependence on periodically collected nitrogen dioxide concentration data and on periodically collected column averaged carbon dioxide concentration data; determining foreground column averaged carbon dioxide concentration data within the emission pixels in dependence on a relationship between nitrogen dioxide concentration data of the periodically collected nitrogen dioxide concentration data and column averaged carbon dioxide concentration data periodically collected column averaged carbon dioxide concentration data; training a machine learning model using column averaged carbon dioxide data of the foreground column averaged carbon dioxide concentration data; inferencing the machine learning model using carbon dioxide concentration data of the foreground column averaged carbon dioxide concentration data determined subsequent to the training; discovering, responsively to the inferencing, enhanced resolution carbon dioxide emissions at emission locations mapping to the emission pixels; and returning, in dependence on the discovering, an action decision for remediation of emissions of carbon dioxide.

In another aspect, a computer program product can be provided. The computer program product can include a computer readable storage medium readable by one or more processing circuit and storing instructions for execution by one or more processor for performing a method. The method can include, for example: identifying emission pixels of a geospatial image map in dependence on periodically collected nitrogen dioxide concentration data and on periodically collected column averaged carbon dioxide concentration data; determining foreground column averaged carbon dioxide concentration data within the emission pixels in dependence on a relationship between nitrogen dioxide concentration data of the periodically collected nitrogen dioxide concentration data and column averaged carbon dioxide concentration data periodically collected column averaged carbon dioxide concentration data; training a machine learning model using column averaged carbon dioxide data of the foreground column averaged carbon dioxide concentration data; inferencing the machine learning model using carbon dioxide concentration data of the foreground column averaged carbon dioxide concentration data determined subsequent to the training; discovering, responsively to the inferencing, enhanced resolution carbon dioxide emissions at emission locations mapping to the emission pixels; and returning, in dependence on the discovering, an action decision for remediation of emissions of carbon dioxide.

In a further aspect, a system can be provided. The system can include, for example, a memory. In addition, the system can include one or more processor in communication with the memory. Further, the system can include program instructions executable by the one or more processor via the memory to perform a method. The method can include, for example: identifying emission pixels of a geospatial image map in dependence on periodically collected nitrogen dioxide concentration data and on periodically collected column averaged carbon dioxide concentration data; determining foreground column averaged carbon dioxide concentration data within the emission pixels in dependence on a relationship between nitrogen dioxide concentration data of the periodically collected nitrogen dioxide concentration data and column averaged carbon dioxide concentration data periodically collected column averaged carbon dioxide concentration data; training a machine learning model using column averaged carbon dioxide data of the foreground column averaged carbon dioxide concentration data; inferencing the machine learning model using carbon dioxide concentration data of the foreground column averaged carbon dioxide concentration data determined subsequent to the training; discovering, responsively to the inferencing, enhanced resolution carbon dioxide emissions at emission locations mapping to the emission pixels; and returning, in dependence on the discovering, an action decision for remediation of emissions of carbon dioxide.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, data sources, client computer devices, mechanical systems, and an application program interface (API) service endpoint according to one embodiment;

FIG. 2A-2B is a flowchart illustrating a method for performance by a manager system interoperating with data sources, UE devices, and an API service endpoint according to one embodiment;

FIG. 3 depicts a sensor data interpolating predictive model according to one embodiment;

FIG. 4A is a flowchart illustrating a method for performance by the manager system according to one embodiment;

FIG. 4B depicts a chart illustrating extrapolating a function based on a relationship between NO₂ data and ΔXCO₂ data according to one embodiment;

FIG. 4C is a chart depicting NO₂ sensor data in comparison to XCO₂ sensor data for a certain cluster of pixels according to one embodiment;

FIG. 5A depicts training data for fine tuning training of a predictive model according to one embodiment;

FIG. 5B depicts a foundational model which can be subject to fine tuning training to define a specific task model according to one embodiment;

FIG. 6 depicts an artificial neural network (ANN) according to one embodiment;

FIG. 7 depicts a computing environment according to one embodiment.

### DETAILED DESCRIPTION

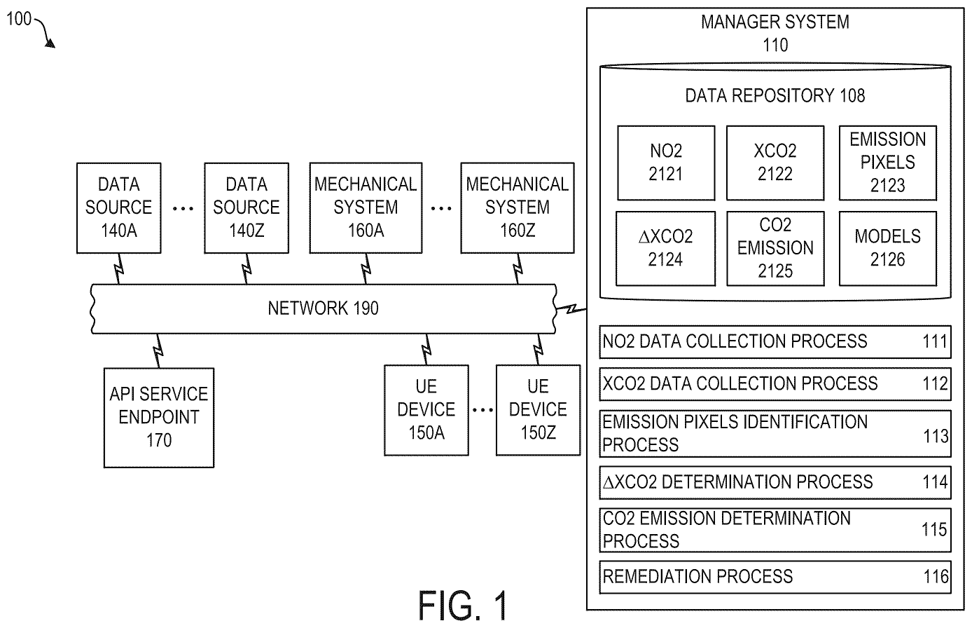

System 100 for use in remediation of CO₂ emissions is shown in FIG. 1. System 100 can include manager system 110 having an associated data repository 108, data sources 140A-140Z, user equipment (UE) devices 150A-150Z, mechanical systems 160A-160Z and API service endpoint 170. Manager system 110, data sources 140A-140Z, UE devices 150A-150Z, mechanical systems 160A-160Z and API service endpoint 170 can be in communication with one another via network 190. System 100 can include numerous devices which can be computing node based devices connected by network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Embodiments herein include features for controlling the amount of greenhouse gas emissions in localized environments, and therefore to mitigate the effect of climate change.

Mechanical systems 160A-160Z can include, e.g., robots, irrigation system, an agricultural treatment system, a roadway sign array, and the like. In one example, manager system 110 can recognize that CO₂ emissions exceed a threshold and can control a mechanical system for remediation of the emission condition.

Data sources 140A-140Z can include, e.g., NO₂ sensors, XCO₂ sensors, and various other types of sensors, including, e.g., OCO2/3 sensors, S5P sensors, GOSAT-2/GW sensors, methane SAT sensors, wind speed sensors, wind directions sensors, temperature sensors, precipitation sensors, solar radiation sensors, land-use sensors and population sensors.

Data repository 108 can store various data. Data repository 108 NO₂ area 2121 can store NO₂ data. NO₂ data can be produced, e.g., by an NO₂ sensor defining one or more of data sources 140A-140Z. In another example, NO₂ data can be provided with use of a machine learning model that interpolates NO₂ data from sensor data of other sensors.

Data repository 108 in XCO₂ area 2122 can store XCO₂ data. XCO₂ data can be produced, e.g., by an XCO₂ sensor. In another example, XCO₂ data can be provided by interpolation use of machine learning model trained to interpolate XCO₂ data based on training data of other sensors. One or more data source of data sources 140A-140Z can be provided by an XCO₂ sensor.

Data repository 108 in emissions pixels area 2123 can store data specifying identified emissions pixels in various geospatial area regions being supported by system 100. In one aspect, manager system 110 can be configured to identify emission pixels based on the relationship between NO₂ data and XCO₂ data.

Data repository 108 in ΔXCO₂ area 2124 can store data that specifies a foreground concentration of CO₂ at identified emission pixels that are specified in emission pixels area 2123 for various geographical regions being supported by system 100.

In one aspect, manager system 110 can identify a foreground concentration of ΔXCO₂ based on a relationship between NO₂ data and XCO₂ data.

Manager system 110 in CO₂ emission area 2125 can store data specifying CO₂ emissions at specific geographical coordinate locations mapping to pixel positions within a geographical region being monitored. In one aspect, manager system 110 can produce CO₂ emission data for storage into CO₂ emissions area 2125 with use of a trained predictive model.

Manager system 110 in models area 2126 can store predictive models that are trained with training data. Predictive models stored within models area 2126 can include one or more model for interpolation of NO₂ data based on sensor data from sensors other than an NO₂ sensors, one or more model for interpolation of XCO₂ data based on sensor data from one or more sensors other than XCO₂ sensors.

Manager system running NO₂ data collection process 111 can include manager system 110 collecting data provided by in NO₂ sensor. In another aspect, manager system 110 running NO₂ data collection process 111 can include manager system 110 inferencing a trained machine learning model trained to interpolate NO₂ data based on training with training data from other sensors. Manager system 110 running XCO₂ data collection process 112 can include manager system 110 collecting data provided by in XCO₂ sensor. In another aspect, manager system 110 running XCO₂ data collection process 112 can include manager system 110 inferencing a trained machine learning model trained to interpolate XCO₂ data based on training with training data from other sensors.

The term XCO₂ stands for “column averaged dry-air mole fraction of carbon dioxide” (hereinafter, column averaged carbon dioxide). It is specifically used in remote sensing and satellite observations to describe the average concentration of CO₂ over a vertical column of the atmosphere. XCO₂ is also expressed in ppm but refers to the average CO₂ level across the entire atmospheric column, from the Earth's surface to the top of the atmosphere, instead of just at ground level.

XCO₂ can be broken down into background XCO₂ and foreground XCO₂ as set forth in Eq. 1.

$${XCO}_{2} = {XCO}_{2} bg + Δ {XCO}_{2} \qquad ( Eq . 1 )$$

Where XCO₂bg is background XCO₂ and ΔXCO₂ is foreground XCO₂. The terms foreground XCO₂ and background XCO₂ describe different aspects of carbon dioxide (CO₂) concentration in the atmosphere, but they have distinct meanings. Background XCO refers to the baseline or average CO₂ concentration in the atmosphere that is relatively unaffected by nearby or localized emissions. It represents a more global, background level of CO₂, often reflecting broader atmospheric mixing and transport of CO₂ over long distances. Background XCO₂, XCO₂bg, provides a reference for understanding the natural or overall atmospheric concentration of CO₂, excluding significant local influences. Foreground XCO₂, ΔXCO₂, refers to the CO₂ concentration in the portion of the atmosphere that is closest to the observer or instrument, typically within the lower atmosphere. It represents the column-averaged CO₂ concentration in the air that is more directly influenced by local or regional sources, such as human activities (e.g., fossil fuel combustion, industrial emissions) or natural processes (e.g., vegetation, soil respiration). In summary, foreground ΔXCO₂ focuses on localized or region-specific CO₂ levels, while background XCO₂ reflects the broader, more stable concentration of CO₂ in the atmosphere, largely free from immediate local emissions.

Embodiments herein recognize that NO₂ can be used as a proxy to help measure foreground ΔXCO₂ in areas where both gases are co-emitted from fossil fuel combustion sources like vehicles and industrial activities. NO₂ is easier to detect due to its stronger absorption features in the visible and ultraviolet spectrum, allowing for precise identification of localized emissions. Since NO₂ concentrations often correlate with CO₂ in these regions, it helps indicate where foreground ΔXCO₂ is elevated. Though NO₂ doesn't directly measure CO₂, combining its data with other atmospheric information, such as wind patterns and temperature, helps refine models for CO₂ emissions. However, limitations arise from their differing behaviors: NO₂ has a shorter atmospheric lifetime and reacts chemically, whereas CO₂ remains stable and disperses more widely. Thus, NO₂ is useful primarily for identifying recent, localized CO₂ emissions rather than for tracking global levels.

Manager system 110 running emission pixel identification process 113 can include manager system 110 identifying emission pixels of a geographical region being supported based on NO₂ data and on XCO₂ data.

Manager system 110 running ΔXCO₂ determination process 114 can include manager system 110 determining the value ΔXCO₂ (foreground CO₂ concentration) based on the relationship between NO₂ data and XCO₂ data.

Manager system 110 running CO₂ emission determination process 115 can include manager system 110 inferencing a trained machine learning model with use of with the determined ΔXCO₂ value determined by running of ΔXCO₂ determination process 114.

The trained machine learning predictive model inferenced by running of CO₂ emissions determination process 115 can be trained with training data that comprises values of ΔXCO₂ over time.

Manager system 110 running remediation process 116 can include manager system 110 returning an action decision in dependence on CO₂ emissions results data. In one example, manager system 110 running remediation process 116 can include manager system 110 can output user interactive user interface prompting data in dependence on CO₂ emission result data. In one example, manager system 110 running remediation process 116 can include manager system 110 controlling a mechanical system of mechanical systems 160A-160Z on response to CO₂ emissions results data.

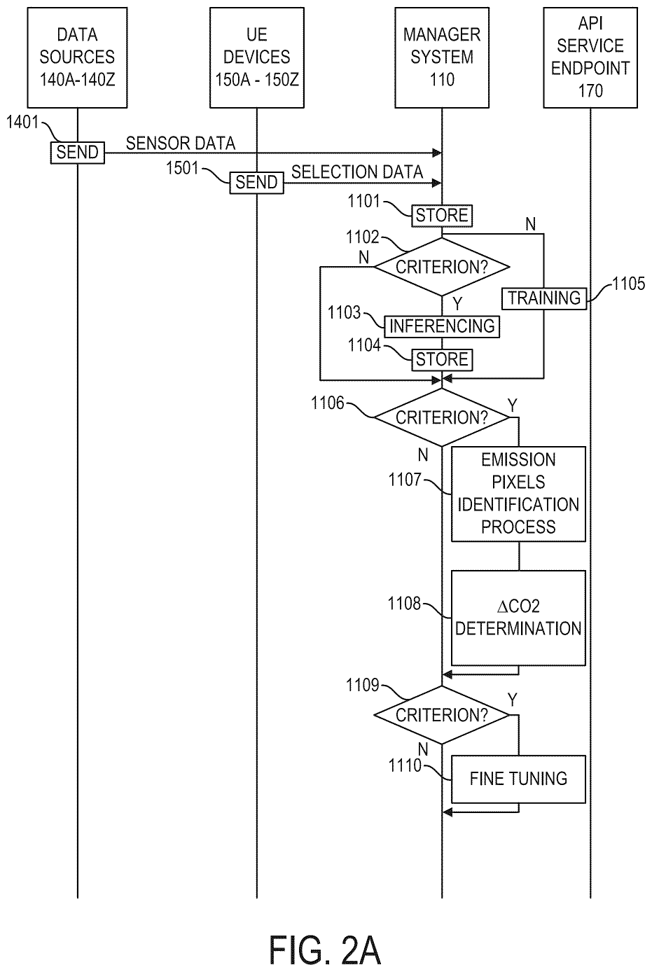

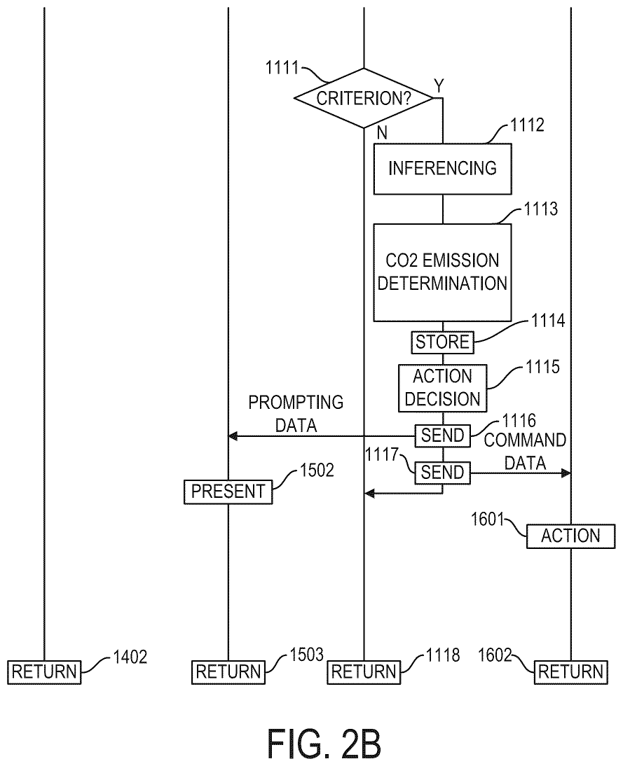

A method for performance by manager system 110 interoperating with data sources 140A-140Z, UE devices 150A-150Z and one or more API service endpoint 170 as set forth in reference to FIGS. 2A-2B.

At block 1401, data sources 140A-140Z can be sending sensor data for receipt by manager system 110. Data sources 140A-140Z can include, e.g., NO₂ sensors, XCO₂ sensors, and various other types of sensors, including, e.g., OCO2/3 sensors, S5P sensors, GOSAT-2/GW sensors, methane SAT sensors, wind speed sensors, wind directions sensors, temperature sensors, precipitation sensors, solar radiation sensors, land-use sensors and population sensors.

At block 1501 UE devices 150A-150Z can be sending selection data that has been defined by administrator users associated to one or more of UE devices of UE devices 150A-150Z. Selection data can include selection data, e.g., to activate remediation of threshold exceeding CO₂ emissions for a specified geographical region selection data for activating training of a predictive model, selection data for configuring a predictive model and the like.

On receipt of sensor data sent at block 1401 and selection data sent at block 1501, manager system 110 can proceed to store block 1101. At store block 1101, manager system 110 can store in data repository 108 the sent sensor data sent and received sensor data in the sent and received selection data. Manager system 110 at store block 1101 can store NO₂ data into NO₂ area 2121 can store XCO₂ data into XCO₂ area 2122.

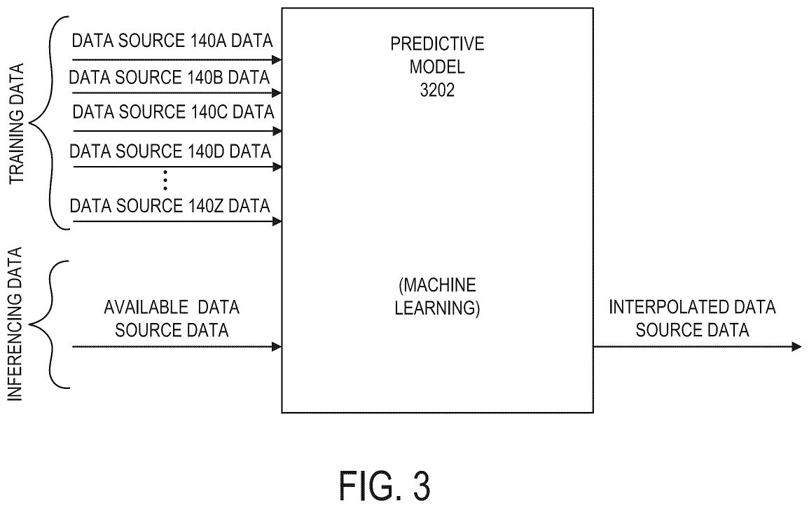

On completion of store block 1101, manager system 110 can proceed to criterion block 1102. At criterion block 1102, manager system 110 can ascertain whether a criterion is satisfied for activating inferencing of a machine learning model for interpolation of sensor data. The criterion of criterion block 1102 can be triggered, for example, when sensor data of NO₂ sensor or an XCO₂ sensor is not available for a particular targeted time stamp range for data collection. On the determination that the criterion block 1102 is satisfied, manager system 110 can proceed to inferencing block 1103. At inferencing block 1103, manager system 110 can perform inferencing of a trained predictive model. Inferencing of a trained predictive model can be performed in a manner described with reference to FIG. 3 showing predictive model 3202 trained to perform interpolation processing for derivation of interpolated sensor data.

Training data for training predictive model 3202 can include data source data from each respective data source of data sources 140A-140Z which data sources can comprise, for each geographical region services, e.g., an NO₂ sensor a XCO₂ and various other types of sensors, including, e.g., OCO2/3 sensors, S5P sensors, GOSAT-2/GW sensors, methane SAT sensors, wind speed sensors, wind directions sensors, temperature sensors, precipitation sensors, solar radiation sensors, land-use sensors and population sensors.

A training regimen for training predictive model 3202 can include self-supervised learning processes so that predictive model 3202 learns relationships between missing sensor data and existing sensor data. In respect to training of predictive model 3202, for example, data source 140A can be provided by an NO₂ sensor. Training of predictive model 3202 in one aspect can include training iterations, wherein sensor data from data sources 140B-140Z, are presented as input training data and sensor data from data source 140A provided by an NO₂ sensor is input as outcome training data. In the described training iteration, the input training data and the outcome training data can all include common timestamps.

In a further training aspect, data source 140B can be provided by an XCO₂ sensor. In training methods for training predictive model 3202 can include presenting data source data source 140 be provided by an XCO₂ sensor as outcome training data and presenting as input training data, data sensor data from the remaining data sources, i.e., data source 140A, 140C-140Z. The described iteration of training data can include sensor data having a common timestamp. In multiple iterations of the described training can be performed.

Trained as described, predictive model 3202 learns a relationship between NO₂ sensor data and remaining sensor data and also learns a relationship between XCO₂ sensor data and remaining sensor data. Trained as described, predictive model 3202 is able to provide predictions as to missing NO₂ sensor data and/or XCO₂ sensor data when such sensor data of a particular target timestamp is missing for a particular geographical region.

Multiple instances of predictive model 3202 can be provided for multiple geographical regions. Predictive model 3202, once trained, can be responsive to inferencing data. Inferencing data can include available data source data when there is detected missing NO₂ sensor data are XCO₂ sensor data for certain targeted timestamp.

On presentment of inferencing data, predictive model 3202 outputs interpolated data source data for the missing data source data, e.g., NO₂ sensor data where NO₂ sensor data from an NO₂ sensor is not available and/or XCO₂ sensor data where NO₂ sensor data from an NO₂ sensor is not available.

On completion of inferencing block 1103, manager system 110 can proceed to store block 1104. At store block 1104, manager system 110 can add to NO₂ area 2122 any interpolated NO₂ sensor data and can add to XCO₂ area any interpolated XCO₂ sensor data.

Referring to training block 1105. training block 1105 can be performed iteratively irrespective of any decision path. At training block 1105, manager system 110 can perform the described training of one or more predictive model 3202 described with reference to FIG. 3.

On completion of store block 1104, manager system 110 can proceed to criterion decision block 1106. At criterion decision block 1106, manager system 110 can ascertain whether sufficient data has been accumulated within data repository 108 for identification of emission pixels. In one illustrative example, at criterion block 1106, manager system 110 can ascertain whether sufficient NO₂ data and XCO₂ data has accumulated within data repository 108. In one example, manager system 110 can determine that sufficient NO₂ data and XCO₂ data have accumulated within data repository 108 when one year of daily NO₂ data and XCO₂ data for a target geographical region has accumulated within data repository 108. In one example, manager system 110 can determine that sufficient NO₂ data and XCO₂ data have accumulated within data repository 108 when one year of weekly NO₂ data and XCO₂ data for a target geographical region has accumulated within data repository 108.

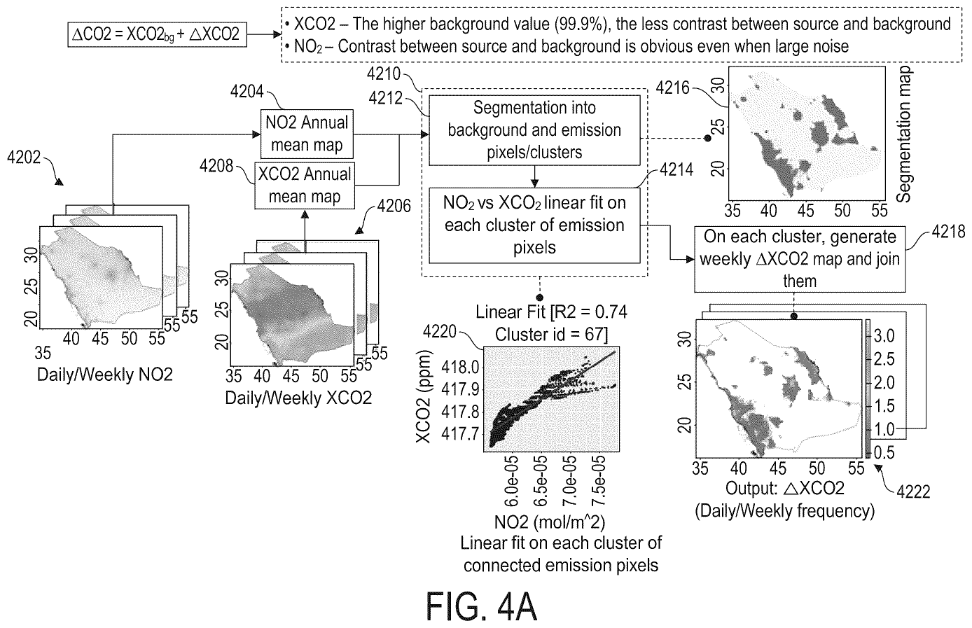

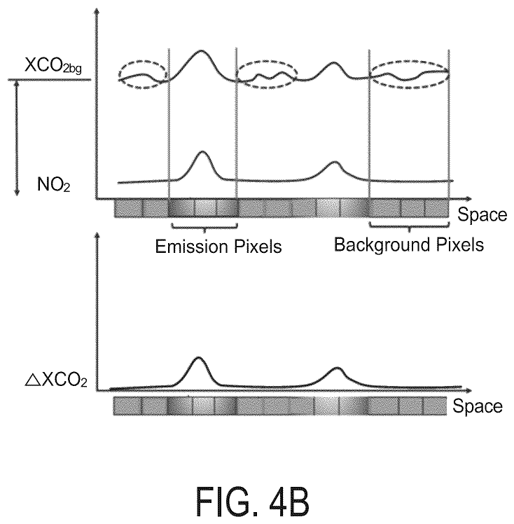

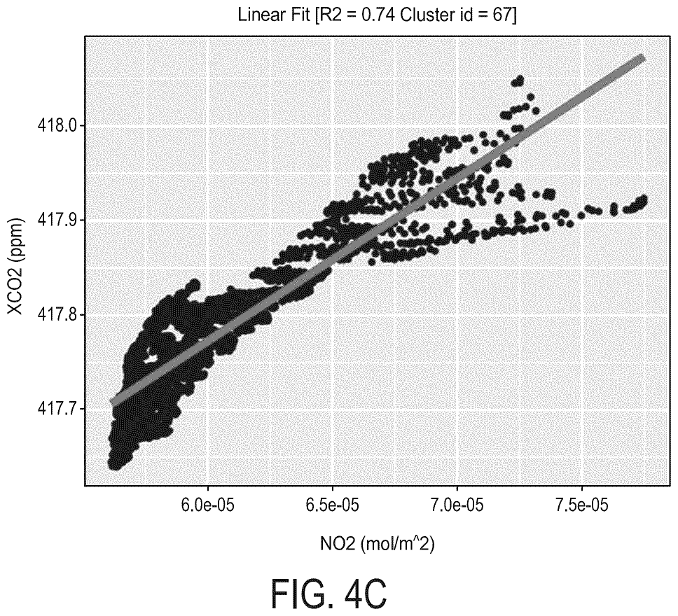

On determination that the criterion block 1106 has been satisfied, manager system 110 can proceed to block 1107. At block 1107, manager system 110 can perform emission pixel identification in the manner as set forth within in reference to FIGS. 4A and 4B.

Referring to FIG. 4A, manager system 110 can aggregate daily or weekly NO₂ maps 4202 and daily and/or weekly XCO₂ maps 4206 to produce an annual NO₂ map 4204 and an annual XCO₂ map 4208. As indicated at processing block 4210, manager system 110 can produce a segmentation map 4216. At processing block 4210, manager system 110 can perform segmentation into background and emission pixels at block 4212 and can extrapolate a function fitting NO₂ data and XCO₂ data at block 4214.

In producing segmentation map 4216 as depicted in FIG. 4A, manager system 110 can evaluate NO₂ pixel data and XCO₂ pixel data. Manager system 110 identifying emission pixels can include manager system 110 examining NO₂ data for various pixels of the described annual maps to XCO₂ data for the same various pixels of the annual XCO₂ map. In one aspect, manager system 110 can ascertain that certain pixels are emission pixels where the NO₂ amplitude pattern for the pixel matches the XCO₂ amplitude pattern for the pixel.

With emission pixels identified using the analysis described in FIG. 4B, manager system 110 can proceed to ΔXCO₂ determination block 1108. At ΔXCO₂ determination block 1108, manager system 110 can derive the determination for ΔXCO₂ for coordinate locations mapping pixel locations within a geographical region. For ascertaining of ΔXCO₂ concentration for various coordinate locations, manager system 110 can perform processing as set forth in reference to FIG. 4C.

In regard to the chart FIG. 4C, manager system 110 can plot for each cluster of pixels determined to be an emission pixel, determined daily/weekly NO₂ sensor data in comparison to determined daily/weekly XCO₂ sensor data. FIG. 4C depicts for a cluster of pixels, weekly NO₂ sensor data in comparison to weekly XCO₂ sensor data. A cluster of pixels herein refers to a set of geometrically connected pixels. A cluster of pixels can include, e.g., a single pixel or multiple pixels. The cluster depicted in FIG. 4C includes a number of pixels equal to the depicted number of plotted data points.

With a chart according to FIG. 4C created for each cluster of pixels identified for a particular geographical region, manager system 110 can extrapolate a function associated to the plotted data for each chart and each identified cluster of pixels. In reference to FIG. 4C, a linear function can be extrapolated. In another example, a curvilinear function can be extrapolated. In one aspect, the y-intercept of the function extrapolated as shown graphically in FIG. 4C can be recorded as the aggregate daily/weekly background XCO₂bg value for a given pixel location.

In another aspect, manager system 110 can establish and set the slope of the extrapolated function as the value ΔXCO₂ for a given cluster of pixels. On completion of ΔXCO₂ determination processing at block 1108, manager system 110 can proceed to criterion block 1109. At criterion block 1109, manager system 110 can ascertain whether a correction factor (CF) machine learning model is ready for fine-tuning training.

Referring to map 4222, manager system 110 can output ΔXCO₂ map 4222 based on the extrapolated function described in reference to FIG. 4C. Manager system 110 can generate ΔXCO₂ map 4222 on a daily or weekly bases, depending on the frequency of collection of NO₂ map 4202 and XCO₂ map 4206. Manager system 110 can generate an ΔXCO₂ map 4222 for each daily or weekly NO₂ map 4202 and XCO₂ map 4206. Manager system 100 can generate, e.g., 52 or 365 ΔXCO₂ maps 4222 depending on the frequency of the described data collection.

At criterion block 1109, manager system 110 can ascertain whether there is sufficient training data with which to complete fine-tune training of a geospatial model for production of a CF machine learning model capable of predicting a correction function (CF) for use in determination of CO₂ emissions. On determination at block 1109 that there is sufficient training data with which to complete fine-tune training, manager system 110 can proceed to fine-tuning block 1110, and at fine-tuning block 1110 can perform fine-tuning training of a geospatial model.

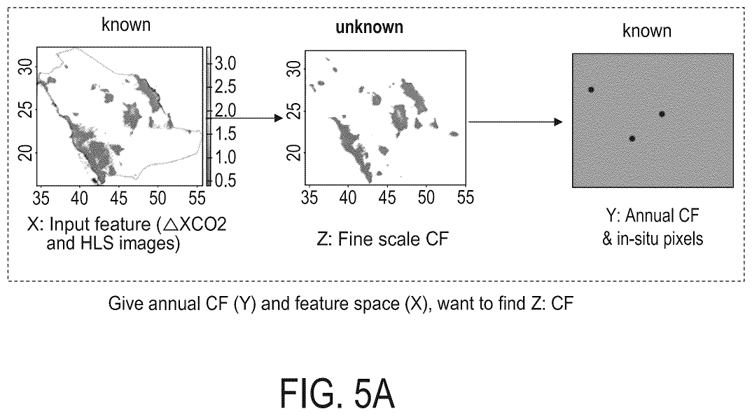

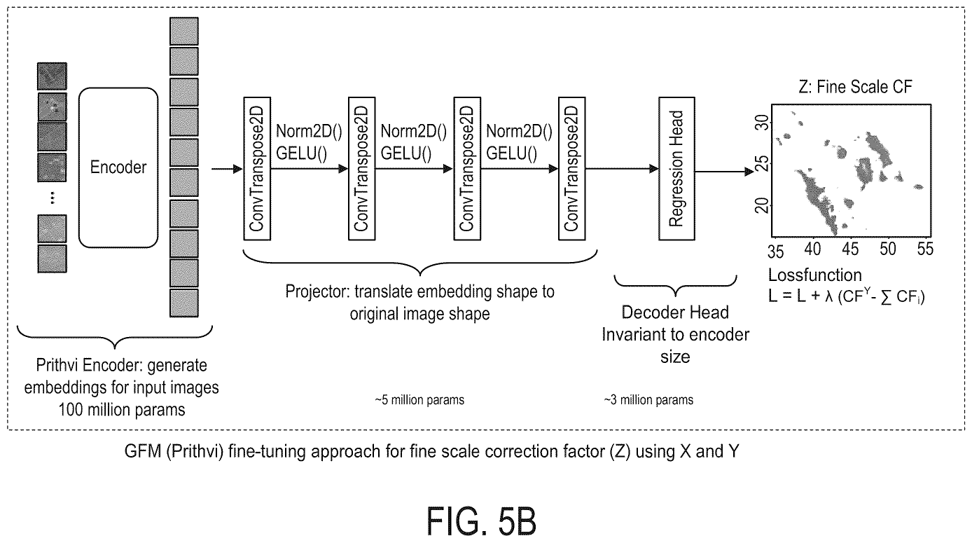

FIG. 5A depicts training scheme for training for performance of fine-tune training of a geospatial model. According to the depicted training scheme, manager system's knowledge of the future space acts in the in the known annual CF for a given geospatial region can determine Z, which is a fine scale determination of CF at coordinate locations mapping to pixel locations.

FIG. 5B depicts a geospatial foundational model which can be subject to fine-tuning training for production of the described CF machine learning model capable of predicting fine resolution correction factors (CF) at coordinate locations mapping the pixel locations.

Embodiments herein recognize that CO₂ emissions can be a function of a correction factor, CF. CO₂ emissions can be a function of a correction factor CF as set forth in Eq. 2 below.

$${CO}_{2} Emission 1 : {CO}_{2} = CF \times Δ {XCO}_{2} \times \frac{V}{L} \qquad ( Eq . 2 )$$

Where ΔXCO₂ (ppm) is enhancement of XCO₂ due to localized activities, V is wind speed (m/s), L is box length. Box length herein can refer to a conceptual or model-based parameter used in atmospheric transport models or carbon cycle studies. It represents the physical or spatial scale (length or distance) over which CO₂ emissions are considered in a particular atmospheric “box” or grid cell. This is often used in large-scale atmospheric models to divide the Earth's atmosphere into a grid or series of boxes, each containing a certain volume of air with specific concentrations of gases like CO₂.

With further reference to Eq. 2, CF refers to a correction factor, calibrated based on historical report annual emission at region (e.g., country) level and in-situ observations at pixels level. The region (e.g., country)-specific correction factor (CF) for CO₂ emissions is calculated by comparing a region (e.g., country) reported emissions with standardized or independent emission inventories, adjusting for discrepancies in emission factors, fuel quality, technology, and energy use data. Emission factors, which vary by region (e.g., country) due to differences in fuel composition and combustion technologies, are a key element, as is the comparison of national energy consumption with global datasets. Additionally, satellite observations can help refine the CF by providing real-world CO₂ concentration data, ensuring the region (e.g., country) emissions align with actual atmospheric measurements. The final CF corrects for underreporting or errors in national inventories. Region (e.g., country)-specific correction factors (CF) for CO₂ emissions are typically derived from international organizations like the IEA, UNFCCC, and databases such as EDGAR, which adjust reported emissions using standardized methodologies. These factors may also come from national agencies, scientific studies, and satellite data like NASA's OCO-2. Although CF values are not always published directly, they are embedded in emissions estimates and models to correct for discrepancies in reporting, fuel quality, and technology differences. Researchers and organizations use these factors to ensure more accurate region (e.g., country)-level emissions reporting and assessments.

Embodiments herein recognize that Eq. 2 produces inaccurate CO₂ emissions determinations due to the fact that the applied correction factor, CF, of Eq. 2 is applied as a constant. Embodiments herein set forth to produce enhanced resolution correction factors, eCF having a resolution in common with the pixel-wise determined ΔXCO₂ values. By use of determined eCF values, CO₂ emissions can be determined based on Eq. 3 below.

$${CO}_{2} Emission 1 : {CO}_{2} = eCF \times Δ {XCO}_{2} \times \frac{V}{L} \qquad ( Eq . 3 )$$

Where ΔXCO₂ (ppm) is enhancement of XCO₂ due to localized activities, V is wind speed (m/s), L is box length, and eCF is an enhanced resolution correction factor having a resolution in common with the determined XCO₂ determined using the method set forth in connection with FIGS. 4A-5C.

For production of high resolution, eCF values, embodiments herein can learn mapping from fine-resolution features to fine-resolution CF values using combination of geospatial foundational model (GFM) features and mass balance concepts.

FIG. 5B illustrates a geospatial foundational model that can be subject to fine-tune training for production of an enhanced correction factor determining machine learning model defined by a specific task model. The geospatial foundational model depicted in FIG. 5B can feature convolution based encoder decoder convolution architecture.

A geospatial foundational model with an encoder-decoder convolutional architecture is highly suited for processing and analyzing spatial data such as satellite images or geographic information. The encoder portion extracts hierarchical features from the input, progressively reducing spatial dimensions using convolutional and pooling layers to capture local patterns like edges, textures, and boundaries, essential for understanding geospatial data such as land cover or urban structures. The decoder reconstructs these compressed representations back to the original spatial resolution using upsampling or transposed convolutions, often including skip connections (as in U-Net) to retain fine-grained details lost during encoding. This architecture is well-suited for tasks like image segmentation, object detection, and change detection, where pixel-level or region-wide information must be predicted. Given the nature of geospatial data, the model is typically adapted to handle multispectral or hyperspectral imagery, where different spectral bands beyond RGB are analyzed for tasks like vegetation monitoring or urban mapping. The model's design also allows it to capture both local features (like roads and small-scale structures) and global context, essential for understanding broader patterns such as regional land use or environmental changes. Techniques like pyramid pooling or atrous convolutions are often used to capture information at multiple spatial scales, crucial for features that exist at different resolutions. Geospatial-specific preprocessing is typically necessary, including the integration of explicit spatial metadata like geographic coordinates or elevation, along with data normalization to account for variability in imagery caused by atmospheric or temporal changes. The model is also highly scalable, benefiting from transfer learning where pre-training on large datasets can improve generalization to specific geospatial tasks and regions, while data augmentation techniques like rotations or scaling help enhance robustness. Additionally, for tasks requiring enhanced focus on specific regions within the data, attention mechanisms may be incorporated, allowing the model to prioritize important areas like roads or rivers over background areas. Overall, this architecture is well-suited to the diverse and complex nature of geospatial tasks, allowing it to capture both detailed local features and broader global patterns while handling multiple spectral bands and adapting to specific geospatial challenges like segmentation, object detection, and temporal change analysis.

Pre-training a geospatial foundational model with an encoder-decoder convolutional architecture is a crucial step to help the model learn useful and transferable representations before fine-tuning it for specific tasks like land cover classification, segmentation, or object detection. In this process, the model is first trained on large-scale, general-purpose datasets, such as satellite imagery from sources like Sentinel-2 or Landsat, which encompass diverse geographic features such as forests, water bodies, urban areas, and agricultural fields. This training can be done using self-supervised learning, where the model learns from the data itself without relying on labeled ground truth. For example, the model might be tasked with predicting missing portions of an image or distinguishing between different patches of the same image based on their relative positions (contrastive learning). This allows the model to discover meaningful patterns and relationships in the data without human annotations.

For fine-tuned training of the geospatial model depicted in FIG. 5B, the feature space acts in the given annual CF for a geospatial region can be applied as training data. A loss function for training the following loss function as set forth in table A can be applied.

TABLE A
(Loss function)

```
A pre-trained geospatial foundation model (GFM) can be subject to fine tune training to refine constant
emission factors across pixels to variable emission factors, using a specific loss function defined as
follows:
                                                      $L = Lo + {λ ( {CF}^{Y} - \sum {CF}_{i} )}^{2} \qquad ( Eq . 4 )$
where CF^{Y} is the predicted emission factor across the region of interest or the sum of emission factors
for all pixels, and CFᵢ is the true (but unknown) emission factor for the i-th pixel. The λ parameter in the
loss function allows us to control the mass balance constraint. For regions with well-documented GHG
emission histories, a larger λ value can be used to enforce the sum constraint more strictly, while smaller
values may be necessary for regions with less-reported data.
Fine-tuning implementation steps:
1. Initialize Emission Factors: Start with a grid of pixels, each pixel assigned a constant emission
  factor value.
2. Fine-tune Model: Fine-tune model that can predict emission factors based on pixel-specific
  characteristics (e.g., X: Input feature).
3. Iterative Optimization:
    ○ Forward Pass: Predict emission factors for each pixel using the current model.
    ○ Calculate Loss: Compute the loss using Eq. 4 between the predicted emission factors
        and the true emission factors.
    ○ Backward Pass: Use backpropagation to update the model's parameters to minimize
        the loss in Eq. 4.
    ○ Repeat: Iterate this process until the loss in Eq. 4 converges to a minimum.
```

The training method described in involves fine-tuning a pre-trained geospatial foundation model (GFM) to refine the emission factors for greenhouse gases (GHG) across different pixels in a geographic region of interest. The goal is to shift from a constant emission correction factor (which might be uniform across pixels) to a variable enhanced emission correction factor eCF that more accurately reflect the true variations in emissions across different locations. This is achieved by using a custom loss function that incorporates a balancing constraint for emissions across the region.

The GFM has already been pre-trained on a large geospatial dataset and likely contains useful information on spatial patterns (e.g., land use, environmental factors) across the region. This pre-training helps the model start with a good representation of the spatial data before fine-tuning it specifically for emission factors.

The fine-tuning process adjusts the model to predict variable emission enhanced correction factors for each pixel, rather than assuming the emission factors are constant across the region. This is important because GHG emissions can vary significantly across different areas based on factors like industrial activity, land use, or natural processes.

Custom Loss Function: The loss function defined in the method is:

$$L = Lo + {λ ( {CF}^{Y} - \sum {CF}_{i} )}^{2} \qquad ( Eq . 4 )$$

Where Lo is the original loss function from the base model (e.g., for pixel-level prediction accuracy or segmentation).

Where CF^{Y} is the predicted emission factor across the entire region, which can be interpreted as the sum of the emission factors predicted by the model for all pixels.

Where CFᵢ is the true emission factor for the i-th pixel (though it's noted that the true values are unknown or uncertain, and this is estimated).

Where 2 is a weighting parameter that controls how strictly the model enforces a mass balance constraint, which ensures that the predicted emissions align with known emission histories or totals for the region.

The described loss function includes a base loss (Lₒ), which measures the prediction error for individual pixel-level emission factors, e.g., using supervised learning with approximate labels or indirect estimates. In the described training scheme daily/weekly ΔXCO₂ values and region (e.g., country)-wide CF factor can be applied as training data.

The sum constraint enforced by λ, which penalizes the model if the total predicted emission factors for all pixels ΣCFᵢ do not match the overall predicted emission factor for the region CF^{Y}. This term ensures that the emissions across all pixels sum to a reasonable total, preventing the model from making locally inaccurate predictions that might add up to an unrealistic total.

λ is a tuning parameter that adjusts how much importance is placed on the mass balance constraint relative to the pixel-level loss:

In regions with well-documented GHG emissions, where the total emissions are well known and reliable, a higher λ value would be used to enforce the constraint more strictly, ensuring that the model's pixel-level predictions sum up closely to the known total.

In regions where emissions data is more uncertain or less well-documented, a lower λ value would be used to allow more flexibility in the pixel-level predictions, as there may be less confidence in the total emissions data.

In one aspect, the GFM can be initialized with pre-trained weights, which already contain a general understanding of spatial patterns in the region. During fine-tuning, the model learns to predict variable emission factors for each pixel in the region of interest. The custom loss function is applied. The base loss (Lo) measures the pixel-level prediction accuracy, while the sum constraint term penalizes deviations between the total predicted emissions for the region and the sum of the pixel-level emission factors. The parameter λ controls the relative importance of the sum constraint.

The model adjusts its predictions to balance both pixel-level accuracy and the overall emission consistency, leading to improved, location-specific emission factors that better reflect real-world variability.

The fine-tuned model can produce variable enhance resolution emission corrections factors, eCF, across the region, allowing for a more nuanced and accurate representation of emissions compared to assuming constant factors. The model incorporates prior knowledge about total regional emissions through the use of the mass balance constraint, ensuring that the pixel-level predictions align with the larger-scale emission estimates. The flexibility in the λ parameter allows the model to be adaptable to regions with varying levels of data availability and confidence, providing a tailored solution for different geographic areas.

The method fine tune trains a pre-trained geospatial model to predict spatially varying emission factors across pixels, balancing pixel-level accuracy with total emission consistency by leveraging a custom loss function with a tunable constraint.

In the context of training a geospatial foundational model (GFM) using ΔXCO₂ foreground values and region (e.g., country) correction factors (CF), these inputs are applied at different stages of the encoder-decoder architecture based on their roles in the model's learning process. Below is an explanation of where and how each is applied in the training process:

ΔXCO₂ foreground values represent the localized, column-averaged CO₂ concentrations (XCO₂) at each pixel across the region of interest. These values are direct measurements or estimates that the model uses to learn the spatial distribution of CO₂ emissions.

ΔXCO₂ foreground values are fed into the encoder as part of the input training data. This data may include other geospatial features, such as multispectral satellite imagery, land cover information, or other contextual data. The XCO₂ values are crucial because they provide localized CO₂ concentration information at each pixel. Manager system 110 can generate, e.g., 52 or 365 ΔXCO₂ maps 4222 described in reference to FIG. 4A depending on the frequency of the described data collection, and data of the 52 or 365 ΔXCO₂ maps 4222 with each map defining an iteration of training data resulting a loss calculation and backpropagation set forth in reference to Table A.

The ΔXCO₂ foreground values pass through the convolutional layers in the encoder. These layers extract hierarchical spatial features and relationships, helping the model learn how local CO₂ concentrations correlate with underlying spatial patterns, such as vegetation, urban areas, or industrial activity. This is where the model starts learning pixel-level emissions.

The ΔXCO₂ foreground values provide detailed, localized data on CO₂ concentrations, which the model uses to learn how to predict pixel-level CO₂ emission factors, eCF. These values allow the encoder to capture both fine-grained and broader spatial patterns that affect CO₂ emissions across the region.

Region (e.g., country) correction factors (CF) provides a reference for the total CO₂ emissions for a given region (e.g., country). They account for potential discrepancies or uncertainties in reporting, adjusting the overall emission predictions to ensure consistency with known emission inventories. CFs are used to balance the model's predictions so that the sum of pixel-level emission factors aligns with the expected emissions for the region.

Region (e.g., country) correction factors (CF) can be applied in the decoder output via the described loss function. The predicted total emissions (sum of pixel-level emission factors) can be compared to the correction factor, ensuring the model's predictions align with regional emission data. The described comparison can be performed to ensure that the sum of pixel-level predictions matches the expected emissions for the region, balancing local accuracy with global consistency.

In one aspect, ΔXCO₂ foreground values can be used as input data in the encoder to inform the model about local CO₂ concentrations, while region (e.g., country) correction factors, CF, are applied as a constraint in the decoder to ensure that the total emissions predicted by the model are consistent with known emission inventories.

Once the encoder processes the ΔXCO₂ foreground values and other geospatial data, the decoder generates predicted enhanced CO₂ emission factors, eCF, for each pixel in the region. These predicted emission factors are summed to estimate the total CO₂ emissions across the region.

The region (e.g., country) correction factors, CF, come into play after the decoder's output, in the loss function. The total predicted emissions (sum of pixel-level predictions) are compared with the emissions calculated using the region (e.g., country) correction factors. This comparison is embedded in a mass balance constraint applied during training.

The loss function of Eq. 4 includes a penalty term to ensure that the sum of the pixel-level emission factors predicted by the decoder matches the region-wide emission totals specified by the region (e.g. country) correction factor. This constraint ensures that the model's output aligns with national or regional emissions data.

The parameter λ in the loss function of Eq. 4 controls how strictly the model adheres to this constraint. For regions with accurate emissions inventories, a higher λ enforces stricter adherence to the correction factors, while a lower λ allows more flexibility when the emission data is less certain.

The region (e.g., country) correction factor ensures that the model's pixel-level predictions are consistent with the broader, known emissions data for the region (e.g., country). This helps the model generalize better and remain accurate at larger scales, preventing the sum of the pixel-level predictions from diverging significantly from the total emissions reported for the region.

In view of the complexity of the relationship between pixel characteristics and emission factors, embodiments herein, embodiments herein can employ a geospatial foundation model as a pre-trained model. The use of a geospatial foundational model can facilitate a more comprehensive understanding of spatial relationships and factors influencing emission factors.

Embodiments herein can employ model testing with use of a variety of model testing metrics including, e.g., Mean Absolute Error (MAE), Root Mean Square Error (RMSE), and Mean Absolute Percentage Error (MAPE).

Once subject to fine-tune training, the geospatial foundational model of FIG. 5B defines a specific task enhanced correction factor predicting model having the specific task of predicting a fine scale enhanced correction factor, eCF determined on a coordinate location basis where the coordinate locations map to pixel locations represented in map data subject to processing for identification of emissions pixels. On completion of fine tuning block 1110, manager system 110 can proceed to criterion block 1111. At criterion block 1111, manager system 110 can ascertain whether request for inferencing the defined specific task model has been activated.

Subsequent to the fine tune training of the machine learning model of FIG. 5B, manager system 110 can apply newly determined ΔXCO₂ map according to ΔXCO₂ map 4222 as inferencing data for inferencing the trained machine learning model, defining an enhanced eCF determining specific task model after training. Subsequent to the fine tune training of the machine learning model, new maps according to ΔXCO₂ map 4222 can be produced by manager system 110 using the last extrapolated NO₂ to XCO₂ function extrapolated according to the process set forth in reference to FIG. 4C.

For performance of criterion block 1111 to determine whether inferencing has been activated, manager system 110 can examine selection data sent at block 1501 and/or the request for inferencing can be determined to be activated based on receipt of sensor values that make available new incoming ΔXCO₂ values where new ΔXCO₂ values are values of ΔXCO₂ determined subsequent to completion of fine-tune training of the geospatial foundational model of FIG. 5B to define a specific task model.

Once trained by fine-tuning training, the geospatial model of FIG. 5B (now defining a specific task enhanced eCF determining model) can be inferenced with inferencing data. The inferencing data for inferencing the fine-tuned trained predictive model of FIG. 5B can include incoming values of ΔXCO₂ calculated as described in reference to FIG. 4A-4C determined subsequent to the training of fine tuning training at fine tuning training block 1110. Based on new incoming values ΔXCO₂, calculated as described in connection with FIG. 4A-4C, manager system 110 can apply the determined ΔXCO₂ values as inferencing data into the geospatial foundational model depicted in FIG. 5B with the geospatial foundational model having been subject to fine tuning training to define a specific task model.

Inferenced as described, the defined specific task model can produce a fine resolution eCF values based on the incoming ΔXCO₂ values. On completion of fine tuning training at block 1110, geospatial foundational model of FIG. 5B defines a specific task model having the associated specific task of predicting fine resolution CF values.

On completion of inferencing at block 1112, manager system 110 can proceed to CO₂ emission determination block 1113. Manager system 110 can employ Eq. 3 for determination of CO₂ emission values.

On completion of CO₂ emission determination block 1113, manager system 110 can proceed to store block 1114. At store block 1114, manager system 110 can store newly determined values of CO₂ emissions into data repository 108 within CO₂ emissions area 2125 of data repository 108. On completion of store block 1114, manager system 110 can proceed to action decision block 1115.

At action decision block 1115, manager system 110 can render one or more action decision in dependence on the CO₂ emission determination at block 1113. The one or more action decision rendered at block 1117 can include one or more action decision to remediate threshold exceeding CO₂ emissions. The one or more action decision can include an action decision to present visualization map on user interface for remediation of threshold exceeding emissions. For remediation of threshold exceeding CO₂ emissions, manager system 110 can perform one or more action.

The one or more action can be an action to generate prompting data defining a heat map in which CO₂ emissions are highlighted in the manner of the heat map depicted in map 4222. In one aspect geospatial CO₂ emission data determined using Eq. 3 can be collected in data repository 108 and can be formatted in a format such as GeoJSON or CSV that contains geographic coordinates and emission levels. A user interface for display on a user interface of a UE device of UE devices 150A-150Z can be configured using a web frameworks like React.js, Vue.js, or Angular for web-based applications. Manager system 110 can employ mapping libraries such as Leaflet.js, Mapbox GL JS, Google Maps API, or Plotly (for Python) to create interactive maps. The CO₂ emission data can be overlaid as heatmap layers, where each data point represents a location with associated emission intensity, with color gradients highlighting high-emission areas in dark gray scale levels and low-emission areas in light gray scale levels. The gray scale level of each displayed pixel can be selected to be proportional to the determined emissions level. In one embodiment Leaflet.js can be used to initialize a map, load the emission data, and apply a heat map layer that adjusts gray scale level based on CO₂ concentration, offering a visual representation of emission hotspots on the map.

Remediating CO₂ emissions involves a combination of advanced technologies and natural processes designed to remove or offset carbon dioxide from the atmosphere, thereby mitigating its impact on climate change. One key method is Carbon Capture and Storage (CCS), which captures CO₂ from industrial processes and power plants before it is released into the atmosphere, and then stores it in geological formations underground. Direct Air Capture (DAC) technologies directly remove CO₂ from the ambient air using chemical processes, allowing it to be stored or repurposed. Afforestation and reforestation are natural methods, where planting trees and restoring forests act as carbon sinks, sequestering CO₂ over long periods. Enhanced weathering involves spreading ground minerals like basalt to chemically react with CO₂ and form stable carbonates, while ocean-based methods, such as marine alkalinity enhancement and large-scale seaweed farming, aim to increase the ocean's capacity to absorb CO₂.

Mechanical systems 160A-160Z can include, e.g., robots, irrigation systems, agricultural treatment systems, roadway sign arrays, carbon capture and storage systems, enhanced oil recovery systems, direct air capture systems, and the like. In one example, manager system 110 can recognize that CO₂ emissions exceed a threshold and can control a mechanical system for remediation of the emission condition. The action decision at block 1115 can include an action decision to activate a mechanical system for remediation of a threshold exceeding CO₂ emission value at a localized area mapping to heat map pixel locations. Examples of action decisions can include, e.g., activating a carbon capture and storage system to reduce CO₂ emissions at a localized area mapping to highlighted heat map pixel locations, activating a direct air capture system to reduce CO₂ emissions at a localized area mapping to highlighted heat map pixel locations, activating an oil recovery system to reduce CO₂ emissions at a localized area mapping to highlighted heat map pixel locations, activating an agricultural treatment system for encouraging tree and foliage growth and/or to spread ground minerals like basalt to chemically react with CO₂ and form stable carbonates at a localized area mapping to highlighted heat map pixel locations, activating roadway sign arrays to direct vehicle traffic away from a localized area mapping to highlighted heat map pixel locations.

Action decisions at block 1115 can also include activating notifications for messaging and prompting users at a localized area mapping to highlighted heat map pixel locations to prompt such users to use public transportation and/or select electric powered vehicle transportation.

In one embodiment, all of the described action decisions and action for remediation can be performed responsively to the emission determination at block 1113. In another aspect, manager system 110 can enable certain ones of the described actions and present the actions in a menu for activation by a user. For example, the described heat map showing CO₂ emissions can be configured as an active user interface with depicted areas of threshold exceeding emissions being configured as active control buttons. On actuation of a control button one or more menu options can be presented for the pixel area selected. The menu options can specify the actions set forth herein, e.g., activating a carbon capture and storage system to reduce CO₂ emissions at a localized area mapping to highlighted heat map pixel locations, activating a direct air capture system to reduce CO₂ emissions at a localized area mapping to highlighted heat map pixel locations, activating an oil recovery system to reduce CO₂ emissions at a localized area mapping to highlighted heat map pixel locations, activating an agricultural treatment system for encouraging tree and foliage growth and/or to spread ground minerals like basalt to chemically react with CO₂ and form stable carbonates at a localized area mapping to highlighted heat map pixel locations, activating roadway sign arrays to direct vehicle traffic away from a localized area mapping to highlighted heat map pixel locations.

On completion of action decision block 1115, manager system 110 can proceed to send block 1116. At send block 1116, manager system 110 can send prompting data for receipt by UE devices of UE devices 150A-150Z. On receipt of the prompting data the respective UE devices 150A-150Z can present the prompting data at present block 1502. The prompting data can depict the heat map described herein with geospatial areas with highlights to indicate CO₂ emissions hotspots. In one aspect, highlighted areas of a geospatial map can take on the features of map 4222 of FIG. 4A, wherein certain pixels are presented in relatively darker grayscale. Displayed prompting data can also include, e.g., prompting data prompting action for remediation of emissions, e.g., messaging and prompting users at a localized area mapping to highlighted heat map pixel locations to prompt such users to use public transportation and/or select electric powered vehicle transportation.

On completion of send block 1116, manager system 110 can proceed to send block 1117. At send block 1117, manager system 110 can send command data to API service endpoint 160. On receipt of the command data by API service endpoint 160, action can be performed as depicted at action block 1601. The command data sent at block 1117 can include, e.g., command data to activate a mechanical system. The command data can include, e.g., command data activating a carbon capture and storage system to reduce CO₂ emissions at a localized area mapping to highlighted heat map pixel locations, activating a direct air capture system to reduce CO₂ emissions at a localized area mapping to highlighted heat map pixel locations, activating an oil recovery system to reduce CO₂ emissions at a localized area mapping to highlighted heat map pixel locations, activating an agricultural treatment system for encouraging tree and foliage growth and/or to spread ground minerals like basalt to chemically react with CO₂ and form stable carbonates at a localized area mapping to highlighted heat map pixel locations, activating roadway sign arrays to direct vehicle traffic away from a localized area mapping to highlighted heat map pixel locations.

On completion of send block 1117, manager system 110 can proceed to return block 1118. At return block 1118, manager system 110 can return to a stage preceding store block 1101 to receive a next iteration of sensor data sent at block 1401 and selection data sent at block 1501. Manager system 110 can iteratively perform the loop of blocks 1101-1118 for deployment period of manager system 110.

Data sources 140A-140Z can iteratively perform the loop of blocks 1401-1402 for the deployment period off data sources 140A-140Z.

UE devices 150A-150Z can iteratively perform the loop of blocks 1501-1503 for the deployment period of UE devices. One or more API service endpoint 170 can iteratively perform the loop at block 1601-1602 for deployment period of API service endpoint 170.

Various available tools, libraries, and/or services can be utilized for implementation of trained predictive models herein trained by machine learning. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, regression-based models, and/or other machine learning technologies.

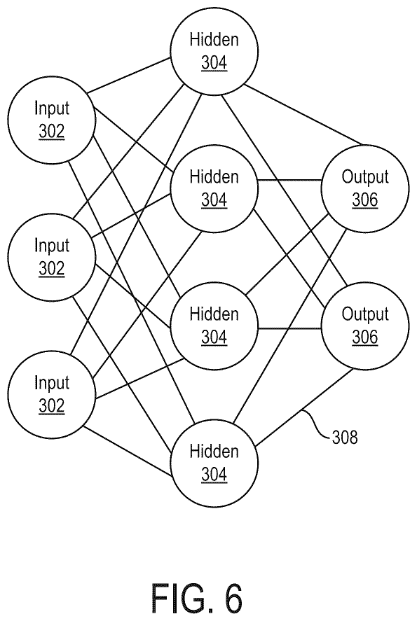

FIG. 6 is an illustration of an example ANN architecture for trained predictive models herein.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons.

Referring now to FIG. 6, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referred to as outcome training data as referenced in connection with predictive models herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Embodiments herein address limited data availability at regular spatio-temporal resolution due to factors like satellite revisit frequency, ground sampling distance (GSD or spatial resolution), cloud coverage, and sensor stability, etc. Addressing this challenge is crucial for achieving regular space/time GHG concentration data.

Embodiments herein recognize that there is a high background concentration of GHGs compared to the incremental increase due to anthropogenic activities. Embodiments herein recognize that addressing this challenge can benefit from first resolving the data scarcity issue. Embodiments herein can include decomposing the GHG concentration into background and (ΔGHG) parts.

Embodiments herein can include performing GHG emission rate estimation: Embodiments herein can include determining a delta part of the GHG concentration (ΔGHG) and predicting the GHG emission rate (or flux) considering continuous transportation and dispersion on the ground.

Embodiments herein provide a system which uses combination of GHG satellite data, weather data and proxy data for anthropogenic activities to map high spatial-temporal resolution GHG concentrations. Embodiments herein can leverage a segmentation-based learning model for decomposition of GHG concentrations to derived background (non-anthropogenic) and anthropogenic GHG concentrations. Embodiments herein can leverage a combination of integrated mass balance and a geospatial foundation model for estimating GHG rate.

Embodiments herein can include a method which uses high spatial temporal resolution GHG concentrations maps and corresponding trace gas maps for performing pixel-wise segmentation. Embodiments herein can perform feedback of gaussian distribution. Embodiments herein can mark pixels as background or anthropogenic labels. Embodiments herein can assign geometrically connected pixels to clusters and can estimate background and anthropogenic GHG concentrations using a learning model.

Embodiments herein can include a method that uses high spatial-temporal resolution GHG concentration maps and corresponding trace gas maps for performing pixel-wise segmentation. Embodiments herein can traverse the trace gas map in strips spanning its length across the geographic region of interest. For each strip, the embodiments identify trace gas values that follow a Gaussian distribution, typically associated with anthropogenic activities. Pixels with insignificant plumes or flattened values are marked as background, while the rest are designated as foreground emission pixels (within Gaussian plumes). This process spans the entirety of the geographic region of interest, resulting in a list of pixels classified as either background or anthropogenic. Embodiments herein can group geometrically connected pixels into clusters and estimate both background and anthropogenic GHG concentrations using a learning model.

For anthropogenic GHG clusters derived, a physics informed mass balance constraint infused geo-spatial foundation model can be employed for finding spatially varied calibration factors for derivation GHG rates due to local activities.

For the first iteration or epoch, the CFY value can be initialized based on the mass balance methodology (the definition of mass balance in GHG content is based on the principle of conservation of mass, which states that the amount of GHG entering a system, minus the amount leaving the system, should equal the change in GHG stored within the system over a given time period). In subsequent iterations or epochs, backpropagation can be used to update the model's parameters to minimize the loss function value (Eq. 4) while continuously updating the pixel-wise calibration factor (CFi) to account for local activities.

Embodiments herein can collect relevant data from various sources for a region of interest (ROI) and a period of interest (POI). Embodiments herein can train a supervised learning ML model and can deploy the ML model to generate a regular space/time GHG concentration map for the ROI and POI. Embodiments herein can decompose the regular space/time GHG concentration into background and delta parts (anthropogenic activity contribution), as set forth herein in connection with FIGS. 4A and 4B. Embodiments herein can utilize the delta GHG concentration for performing a fine-tuning procedure for fine tuning a geospatial foundation model to define a specific task model, which specific task model can be inference for conversion of a delta GHG concentration into a GHG emission rate (flux).

Embodiments herein can include collecting relevant data from various sources and pre-processing the relevant data for specific satellite observation locations and times. The pre-processed data can then be used to create a database. The created database can be used to train a supervised learning ML model. Finally, the trained ML model can be deployed to generate a regular space/time map of GHG concentration for the ROI and POI. During deployment, an upscaling or downscaling step can be performed to ensure compatibility with the target resolution.

Embodiments herein can perform decomposition of GHG concentration. Embodiments herein can decompose input GHG concentration into background and delta (anthropogenic activity contribution) values. Embodiments herein can address the challenge of separating the high background concentration from the smaller increment due to human activities.

Embodiments herein can segment temporally aggregated input GHG concentration map into background and emission pixels/clusters. In reference to map 4216 depicted in FIG. 4A, white pixels represent areas with no detected anthropogenic (local) activities, and dark pixels/clusters (groups of connected pixels) represent areas with detected anthropogenic activities.

As set forth in reference to FIG. 4C, function extrapolation, e.g., curve fitting, can be applied to each identified emission cluster. As an example, the chart of FIG. 4C shows NO₂ data on the x-axis and XCO₂ data on the y-axis. The slope of the fitted line specifies the delta GHG, e.g., ΔXCO₂ (the value of interest), and the intercept represents the background GHG concentration for that cluster. By combining delta GHG values from all clusters across the ROI and POI, the final output is a map of delta GHG concentration, as shown by map 4222 of FIG. 4A. FIG. 4C shows the weekly values for a particular week of all pixels for NO₂ versus XCO₂ for a particular cluster ID, which is a collection of geometrically connected pixels. FIG. 4C shows data for many pixels from the same cluster. In general, a cluster can be formed with a single pixel, while in some cases, a cluster can consist of several pixels.

There is set forth herein, in one aspect, a system which uses combination of GHG satellites data, weather data and proxy data for anthropogenic activities to map high spatial-temporal resolution GHG concentrations, leverages novel segmentation-based learning model for decomposition of GHG concentrations to derived background (non-anthropogenic) and anthropogenic GHG concentrations and leverages combination of integrated mass balance and geospatial foundation model for estimating GHG rate.

A method which uses high spatial temporal resolution GHG concentrations maps and corresponding trace gases maps to do pixel-wise segmentation with of feedback of gaussian distribution and marked pixels as background or anthropogenic labels and further geometrically connected pixels are assigned to form clusters and estimate background and anthropogenic GHG concentrations using a learning model.

For anthropogenic GHG clusters derived in above the step, a novel physics informed mass balance constrain infused geo-spatial foundation model is proposed for finding spatially varied calibration factors to derived GHG rates due to local activities.

Certain embodiments herein may offer various technical computing advantages involving computing advantages to address problems arising in the realm of computer networks. Embodiments herein can include feature improvements and technologies involving CO₂ emissions terminations and can facilitate CO₂ emission determination on a fine resolution scale so that CO₂ emissions can be determined. In one aspect, CO₂ emissions can be determined that at coordinate locations mapping the pixel positions. Embodiments herein can feature use of machine learning models that interpolate missing sensor data based on output data of a plurality of sensors. Embodiments herein can feature a new feature use of a geospatial foundational model that has been subject to fine-tuned training to define a specific test model where the specific test models capable of producing predictions as to find resolution correction factor CF use in return of CO₂ emission determinations. Embodiments herein can feature improvements and technologies of CO₂ emissions remediations. Embodiments herein include features for controlling the amount of greenhouse gas emissions in localized environments, and therefore to mitigate the effect of climate change. Improvements can include improvements in the resolution of CO₂ emissions determinations so that mediations can be accurately performed at geospatial coordinate locations where remediations can accurately address directly determined emissions. By accurate determination of CO₂ emissions on a fine resolution scale, mediations can be implement at fine grain locations where the remediations not been wasted, and thus, embodiments herein can feature resource including computing resource economizations. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

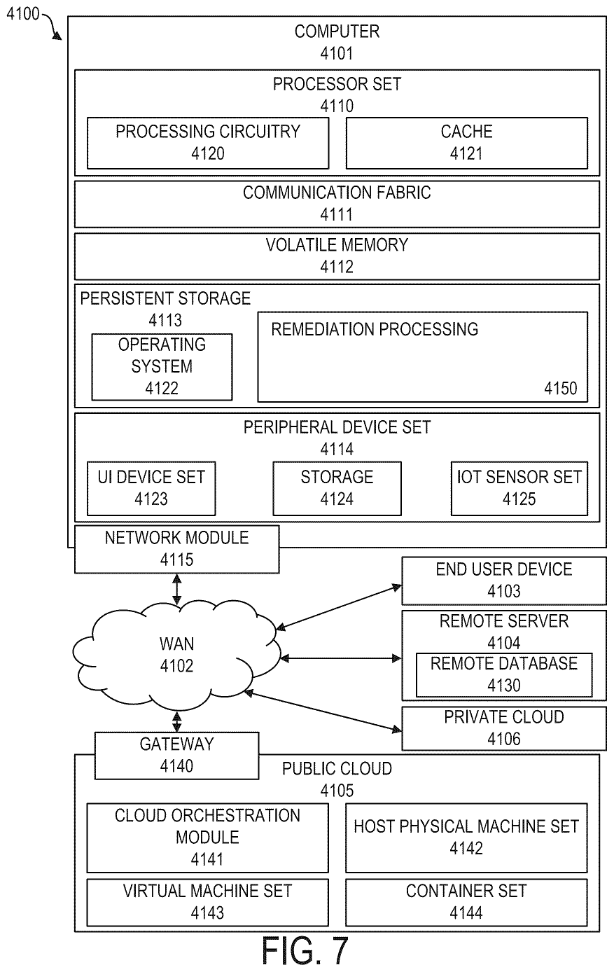

In reference to FIG. 7 there is set forth a description of a computing environment 4100 that can include one or more computer 4101. In one example, computing node 10 as set forth herein can be provided in accordance with computer 4101 as set forth in FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Hash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 7. In one aspect, a computing environment 4100 contains an example of an environment for the execution of at least some of the computer code involved in performing the inventive methods, such as code 4150 for performing remediation processing described with reference to FIGS. 1-6. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

1. A computer implemented method comprising:
identifying emission pixels of a geospatial image map in dependence on collected nitrogen dioxide concentration data and on periodically carbon dioxide concentration data;
determining foreground carbon dioxide concentration data within the emission pixels in dependence on a relationship between nitrogen dioxide concentration data of the collected nitrogen dioxide concentration data and concentration data of the collected carbon dioxide concentration data;
training a machine learning model using carbon dioxide data of the foreground carbon dioxide concentration data;
inferencing the machine learning model using concentration data of the foreground carbon dioxide concentration data;
discovering, responsively to the inferencing, enhanced resolution carbon dioxide emissions at emission locations mapping to the emission pixels; and
returning, in dependence on the discovering, an action decision for remediation of emissions of carbon dioxide.

2. The computer implemented method of claim 21, wherein the machine learning model is a geospatial foundational model that defines an enhanced correction factor determining specific task model on being trained by the training.

3. The computer implemented method of claim 21, wherein the machine learning model is a geospatial foundational model having an encoder decoder convolution network architecture, and wherein the machine learning model defines an enhanced correction factor determining specific task model on being trained by the training.

4. The computer implemented method of claim 21, wherein the method includes producing, from the inferencing, enhanced resolution correction factor values, and wherein the discovering includes performing the discovering in dependence on the enhanced resolution correction factor values.

5. The computer implemented method of claim 21, wherein the method includes producing, from the inferencing, enhanced resolution correction factor values having a resolution matching a resolution of the identified emission pixels, and wherein the discovering includes performing the discovering in dependence on the enhanced resolution correction factor values.

6. The computer implemented method of claim 21, wherein the periodically collected nitrogen dioxide concentration data includes interpolated nitrogen dioxide concentration data that is interpolated in dependence on inferencing of a trained predictive model that has been training with sensor training data other than nitrogen dioxide concentration sensor data.

7. The computer implemented method of claim 21, wherein the periodically collected column averaged carbon dioxide concentration data includes interpolated column averaged carbon dioxide concentration data that is interpolated in dependence on inferencing of a trained predictive model that has been training with sensor training data other than column averaged carbon dioxide concentration sensor data.

8. The computer implemented method of claim 421, wherein the action decision is an action decision for controlling a mechanical system.

9. The computer implemented method of claim 421, wherein the action decision is an action decision for presentment of prompting data on a user interface.

10. The computer implemented method of claim 21, wherein the machine learning model includes an encoder and a decoder, and wherein the training of the machine learning model includes applying the column averaged carbon dioxide data of the foreground column averaged carbon dioxide concentration data to the encoder, and applying a regional correction factor, CF, to the decoder via a loss function.

11. The computer implemented method of claim 21, wherein the machine learning model includes an encoder and a decoder, and wherein the training of the machine learning model includes applying the column averaged carbon dioxide data of the foreground column averaged carbon dioxide concentration data to the encoder, and applying a regional correction factor, CF, to the decoder via a loss function, wherein during the training the decoder is configured to predict pixel-level enhanced emission correction values, eCF, wherein the loss function includes a penalty term to ensure that a sum of the pixel-level enhanced emission correction factors, eCF, predicted by the decoder matches the regional emission correction factor.

12. The computer implemented method of claim 21, wherein the machine learning model includes an encoder and a decoder, and wherein the training of the machine learning model includes applying the column averaged carbon dioxide data of the foreground column averaged carbon dioxide concentration data to the encoder, and applying a regional correction factor, CF, to the decoder via a loss function, wherein during the training the decoder is configured to predict pixel-level enhanced emission correction values, eCF, wherein the loss function includes a penalty term to ensure that a sum of the pixel-level enhanced emission correction factors, eCF, predicted by the decoder matches the regional emission correction factor, wherein as a result of the training, the machine learning training defines a specific task model configured to output predictions of pixel-level enhanced emission correction values, eCF, when inferenced by the inferencing the machine learning model using carbon dioxide concentration data of the foreground column averaged carbon dioxide concentration data determined subsequent to the training.

13. A system comprising:
a memory;
at least one processor in communication with the memory; and
program instructions executable by one or more processor via the memory to perform a method comprising:
identifying emission pixels of a geospatial image map in dependence on periodically collected nitrogen dioxide concentration data and on periodically collected column averaged carbon dioxide concentration data;
determining foreground column averaged carbon dioxide concentration data within the emission pixels in dependence on a relationship between nitrogen dioxide concentration data of the periodically collected nitrogen dioxide concentration data and column averaged carbon dioxide concentration data of the periodically collected column averaged carbon dioxide concentration data, the determined foreground values being prepared for encoder ingestion;
training a machine learning model using column averaged carbon dioxide data of the foreground column averaged carbon dioxide concentration data, the training including applying the foreground carbon-dioxide data to an encoder of the model and updating decoder parameters in dependence on a regional correction factor;
inferencing the machine learning model using carbon dioxide concentration data of the foreground column averaged carbon dioxide concentration data determined subsequent to the training;
discovering, responsively to the inferencing, enhanced resolution carbon dioxide emissions at emission locations mapping to the emission pixels, the discovering enabling selection of a remediation action; and
returning, in dependence on the discovering, an action decision for remediation of emissions of carbon dioxide, and transmitting command data in accordance with the action decision.

14. (canceled)

15. (canceled)

16. (canceled)

17. (canceled)

18. (canceled)

19. (canceled)

20. (canceled)

21. A computer implemented method comprising:
identifying emission pixels of a geospatial image map in dependence on periodically collected nitrogen dioxide concentration data and on periodically collected column averaged carbon dioxide concentration data;
determining foreground column averaged carbon dioxide concentration data within the emission pixels in dependence on a relationship between nitrogen dioxide concentration data of the periodically collected nitrogen dioxide concentration data and column averaged carbon dioxide concentration data of the periodically collected column averaged carbon dioxide concentration data;
training a machine learning model using column averaged carbon dioxide data of the foreground column averaged carbon dioxide concentration data;
inferencing the machine learning model using carbon dioxide concentration data of the foreground column averaged carbon dioxide concentration data determined subsequent to the training;
discovering, responsively to the inferencing, enhanced resolution carbon dioxide emissions at emission locations mapping to the emission pixels; and
returning, in dependence on the discovering, an action decision for remediation of emissions of carbon dioxide.

22. The computer-implemented method of claim 21, wherein the machine learning model includes an encoder and a decoder, and wherein the training of the machine learning model includes applying the carbon dioxide data of the foreground carbon dioxide concentration data to the encoder and updating decoder parameters in dependence on a regional correction factor, CF, via a loss function configured to cause the decoder to learn enhanced-emission behavior.

23. The computer-implemented method of claim 21, wherein the method includes transmitting to an API service endpoint command data in accordance with the action decision to activate a mechanical system for carbon-dioxide-emission remediation, and wherein the training of the machine learning model includes applying the carbon dioxide data of the foreground carbon dioxide concentration data to the encoder and updating decoder parameters in dependence on a regional correction factor, CF, via a loss function configured to cause the decoder to learn enhanced-emission behavior.

24. The method of claim 1, wherein the method includes activating a carbon removal system configured to extract carbon dioxide from ambient air in accordance with the action decision.

25. The computer-implemented method of claim 1, wherein the method includes transmitting to an API service endpoint command data in accordance with the action decision, the command data being configured to activate a mechanical system to perform carbon dioxide emission remediation.

26. The computer-implemented method of claim 1, wherein the machine learning model includes an encoder and a decoder, and wherein the training of the machine learning model includes applying the carbon dioxide data of the foreground carbon dioxide concentration data to the encoder and updating decoder parameters in dependence on a regional correction factor, CF, via a loss function configured to cause the decoder to learn enhanced-emission behavior.

27. The computer-implemented method of claim 1, wherein the method includes transmitting to an API service endpoint command data in accordance with the action decision to activate a mechanical system for carbon-dioxide-emission remediation, and wherein the training of the machine learning model includes applying the carbon dioxide data of the foreground carbon dioxide concentration data to the encoder and updating decoder parameters in dependence on a regional correction factor, CF, via a loss function configured to cause the decoder to learn enhanced-emission behavior.
